(19) United States
(12) Patent Application Publication
(10) Pub. No.: US 2010/0188748 A1
(43) Pub. Date: Jul. 29, 2010

(54) POLARIZATION COMPENSATION OPTICAL SYSTEM AND POLARIZATION COMPENSATION OPTICAL ELEMENT USED THEREIN

(75) Inventors: Masahiro MIZUTA, Kawasaki-shi (JP); Kumiko Matsui, Yokohama-shi (JP)

Correspondence Address: MILES & STOCKBRIDGE PC, 1751 PINNACLE DRIVE, SUITE 500, MCLEAN, VA, 22102-3833, US

(73) Assignee: NIKON CORPORATION

(21) Appl. No.: 12/752,102

(22) Filed: Mar. 31, 2010

Related U.S. Application Data
(63) Continuation of application No. PCT/JP2008/067972, filed on Sep. 26, 2008.

(30) Foreign Application Priority Data
Oct. 1, 2007 (JP) 2007-257063

(51) Int. Cl. G02B 27/28

(52) U.S. Cl. 359/489; 359/485; 359/499

(57) ABSTRACT

A polarization compensation optical system includes: a light source 1 that illuminates a sample 4 with illumination light through a polarizer P, a collector lens 2, a condenser lens 3, an objective lens 5 that converges light from the sample 4 and forms an image through an analyzer A, and a polarization compensation optical element C (C1, C2) that is disposed at least one of a space between the polarizer P and the sample 4, and a space between the sample 4 and the analyzer A, divided into a plurality of areas within an effective diameter, and corrects rotation of polarization direction and phase difference generated by optical elements disposed between the polarizer P and the analyzer A at each area, and the division number of the areas of the polarization compensation optical element C (C1, C2) is 8 or more.

### TECHNICAL FIELD

The present invention relates to a polarization compensation optical system and a polarization compensation optical element used in the optical system.

### BACKGROUND ART

In a microscope optical system using linearly polarized light, there has been a problem that because of an effect of refractive surfaces of lenses composing the microscope optical system or various coatings applied to the lenses, polarization direction of linearly polarized light rotates to become elliptical polarization, so that contrast of an image and a signal to noise ratio of the image become worse. Since the problem is conspicuous in such cases that the number of refractive lens surfaces is large, refractive power of the refractive surface is strong, or an antireflection coating applied to the refractive surface is a multilayer coating, it becomes particularly problematic in a high numerical aperture objective lens whose aberrations are excellently corrected. In order to solve the problem, there has been known a polarization compensation optical element that compensates linearly polarized light to become elliptical polarization light by combining a half-wave plate with a lens that has no-power and has almost the same polarization property as the microscope optical system (see, for example, Japanese Examined Patent Application Publication No. 37-005782).

However, in a conventional polarization compensation optical element, since one or a plurality of bulky elements have to be disposed to designated positions on an optical path of the microscope with high precision, exchange of the polarization compensation optical element upon changing an objective lens of the microscope has been difficult problem. Moreover, a polarization compensation optical element has to be a fixed one to a designated optical system. As a result, although rotation of polarization direction and elliptical polarization can be compensated upon using the designated objective lens, compensation is not sufficient and contrast of an image and a signal to noise ratio of the image are also not sufficient upon changing the objective lens, so that it has been a problem.

### DISCLOSURE OF THE INVENTION

The present invention is made in view of aforementioned problems, and has an object to provide a polarization compensation optical system including a polarization compensation optical element capable of compensate rotation of polarization direction and a phase difference of the polarization optical system with high precision even upon changing an objective lens.

In order to solve the problem, a polarization compensation optical system according to a first aspect of the present invention comprises: an illumination optical system (for example, a light source 1, a collector lens 2 and a condenser lens 3 in the embodiment) that illuminates a sample (for example, a sample 4 in the embodiment) with polarized illumination light; an imaging optical system (for example, an objective lens 5 in the embodiment) that images the light from the sample whose polarization state is varied by the sample through an analyzer; and a polarization compensation optical element that is disposed at least one of the illumination optical system and a space between the sample and the analyzer, and corrects rotation of polarization direction and phase difference generated by optical elements disposed between the sample and the analyzer, and optical elements disposed in the illumination optical system; the polarization compensation optical element is divided into a plurality of areas in a circumferential direction and in a radial direction on an optical axis of the illumination optical system and the imaging optical system, when a number of division of the plurality of areas is denoted by N, the number of division in the radial direction is denoted by α, and the number of division in the circumferential direction is denoted by β, the following conditional expressions is satisfied:

8≦N

2≦β/α≦3.

In the polarization compensation optical system according to the first aspect, it is preferable that a phase plate is disposed in each area of the polarization compensation optical element, and the phase plate is made of a structural birefringent optical member.

In the polarization compensation optical system according to the first aspect, it is preferable that a phase plate is disposed in each area of the polarization compensation optical element, and the phase plate is made of a photonic crystal.

In the polarization compensation optical system according to the first aspect, it is preferable that the polarization compensation optical element is formed by a plurality of layers including: a first division-type phase plate that is formed by disposing and combining a plurality of quarter-wave plates with orienting phase axes thereof to respective given directions corresponding to the plurality of areas whose phase differences are different with each other; and a second division-type phase plate that is formed by disposing and combining a plurality of half-wave plates with orienting phase axes thereof to respective given directions corresponding to the plurality of areas whose phase differences are different with each other.

In the polarization compensation optical system according to the first aspect, it is preferable that the quarter-wave plate and the half-wave plate are made of a structural birefringent optical member.

In the polarization compensation optical system according to the first aspect, it is preferable that the quarter-wave plate and the half-wave plate are made of a photonic crystal.

In the polarization compensation optical system according to the first aspect, it is preferable that the polarization compensation optical element is divided in a grid shape.

In the polarization compensation optical system according to the first aspect, it is preferable that the illumination optical system includes a polarizer, and the polarized illumination light is formed by the polarizer.

According to a second aspect of the present invention, there is provided a polarization compensation optical element, whose effective diameter is divided into a plurality of areas in a circumferential direction and in a radial direction, for compensating rotation of polarization direction and phase difference, the polarization compensation optical element comprising: phase plates each of which is disposed in each area composed of at least one layer for providing different phase difference, and orient respective phase axes thereof to given directions different with each other; and the following conditional expressions being satisfied:

8≦N

2≦β/α≦3

where N denotes a number of division of the areas of the polarization compensation optical element, α denotes the number of division in the radial direction, and β denotes the number of division in the circumferential direction.

In the second aspect of the present invention, it is preferable that the phase plate is made of a structural birefringent optical member.

In the second aspect of the present invention, it is preferable that the phase plate is made of a photonic crystal.

In the second aspect of the present invention, it is preferable that the phase plate is formed by a plurality of layers including: a first division-type phase plate that is formed by disposing and combining a plurality of quarter-wave plates with orienting phase axes thereof to respective given directions corresponding to the plurality of areas whose phase differences are different with each other; and a second division-type phase plate that is formed by disposing and combining a plurality of half-wave plates with orienting phase axes thereof to respective given directions corresponding to the plurality of areas whose phase differences are different with each other.

In the second aspect of the present invention, it is preferable that the quarter-wave plate and the half-wave plate are made of a structural birefringent optical member.

In the second aspect of the present invention, it is preferable that the quarter-wave plate and the half-wave plate are made of a photonic crystal.

In the second aspect of the present invention, it is preferable that the effective diameter is divided in a grid shape.

With constructing the polarization compensation optical system according to the present invention, and the polarization compensation optical element used in the optical system in the above stated manner, it becomes possible to precisely compensate rotation of polarization direction and a phase difference even upon changing an objective lens.

### BRIEF DESCRIPTION OF THE DRAWINGS

FIG. 1 is a schematic diagram showing a transmission-illumination type polarization microscope that is a polarization compensation optical system according to a first embodiment.

FIG. 2A is a schematic diagram showing rotation of polarization direction of an optical system when the light transmitted through the lens has a large angle.

FIG. 2B is a schematic diagram showing rotation of polarization direction of an optical system when a lot of antireflection coatings are applied to the lens surfaces.

FIG. 3A is a schematic diagram showing an example of a division-type phase plate which is a polarization compensation optical element.

FIG. 3B is a schematic diagram showing an example of a gradient phase plate which is a polarization compensation optical element.

FIGS. 4A through 4C are graphs schematically showing an effect of a structural birefringent optical member according to a first construction method.

FIGS. 5A through 5C are graphs schematically showing an effect of a structural birefringent optical member according to a second construction method.

FIG. 6 is a schematic diagram showing a variation according to the first embodiment.

FIG. 7 is a schematic diagram showing a transmission-illumination-type [sic] polarization microscope that is a polarization compensation optical system according to a second embodiment.

FIG. 8 is a schematic diagram showing a variation according to the second embodiment.

FIG. 9 is a graph showing incident angle dependency of a rotation of polarization axis.

FIG. 10 is a graph showing incident angle dependency of a phase difference.

FIG. 11A is a schematic diagram showing a polarization compensation optical element used in a simulation in which the element is evenly divided in a radial direction and in a circumferential direction.

FIG. 11B is a schematic diagram showing a polarization compensation optical element used in a simulation in which the element is evenly divided in a circumferential direction, but is divided finer in the radial direction as a numerical aperture becomes larger.

FIG. 12 is a schematic diagram showing a polarization compensation optical element divided in a grid shape.

FIG. 13 is a graph showing a variation in extinction ratio of an optical system 1 with respect to a circumferential direction division number and a radial direction division number of a polarization compensation optical element when one polarization compensation optical element is disposed in the vicinity of a primary focal plane of a condenser lens.

FIG. 14 is a graph showing a variation in extinction ratio of an optical system 2 with respect to a circumferential direction division number and a radial direction division number of a polarization compensation optical element.

FIG. 15 is a graph showing a variation in extinction ratio of an optical system 3 with respect to a circumferential direction division number and a radial direction division number of a polarization compensation optical element.

FIG. 16 is a graph showing a relation between extinction ratio and division number.

### EMBODIMENT FOR CARRYING OUT THE INVENTION

A preferred embodiment of the present invention is explained with reference to accompanying drawings.

### First Embodiment

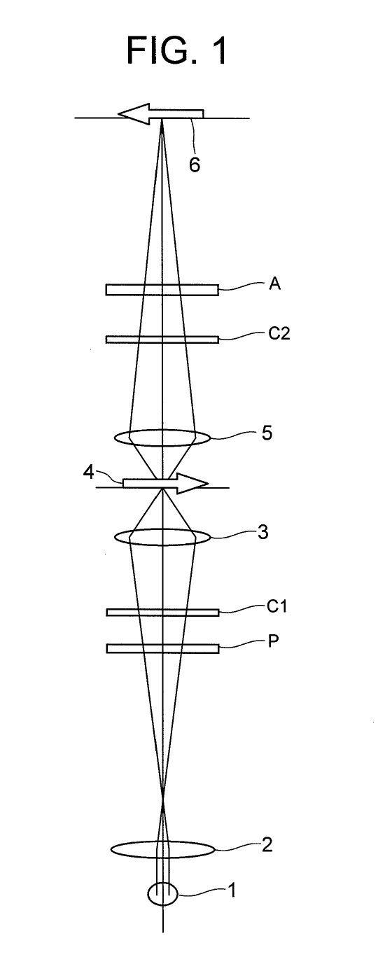

FIG. 1 is a schematic diagram showing a polarization compensation optical system according to a first embodiment of the present invention. In the first embodiment, a transmission-illumination-type polarization microscope is taken up as a typical example of a polarization compensation optical system, and the polarization compensation optical system whose rotation of polarization direction and phase difference generated in the optical system are compensated is explained.

In FIG. 1, illumination light from a light source 1 is converged by a collector lens 2, illuminates a sample 4 placed on an unillustrated slide glass through a condenser lens 3. The light from the illuminated sample 4 is converged by an objective lens 5 to form an enlarged image 6. An observer observes the enlarged image 6 by a naked eye through an unillustrated eyepiece. A polarizer P is disposed on an optical path between the collector lens 2 and the condenser lens 3, and an analyzer A is disposed on the optical path between the objective lens 5 and the enlarged image 6. The polarizer P and the analyzer A are generally disposed such that the transmission directions of them are crossed at right angles (crossed Nicol disposition). Incidentally, illumination light illuminating an object is not limited to polarized light transmitted through the polarizer P, and polarized light generated by reflecting a polarizer, or polarized light generated directly from a light source such as a laser light source may be used.

In such a construction, when a sample 4 is not placed on the slide glass, the field becomes completely dark. In this state, when, for example, a thin sample 4 of a mineral is placed, the histologic structure of the sample 4 becomes visible by producing light and shade in accordance with difference in polarization states of each portion of the sample 4. In such a polarization microscope, in order to detect slight variation in polarization state of the sample with high precision by visualization, disturbance of polarization state generated in the optical system other than the sample has to be avoided as much as possible.

However, it often happens that optical systems such as a condenser lens 3, an objective lens 5, and the like are disposed between the polarizer P and the analyzer A, so that even if the polarizer P and the analyzer A are in a crossed Nicols state, extinction ratio is lowered by disturbance of polarization state of the optical system resulting in lowering detection ability of the microscope. This is conspicuous in a high magnification objective lens 5. The major causes are such that the number of reflective lens surface disposed in the objective lens 5 is large, a refractive angle on each lens surface is large, and polarization property of an antireflection coating applied on each lens surface.

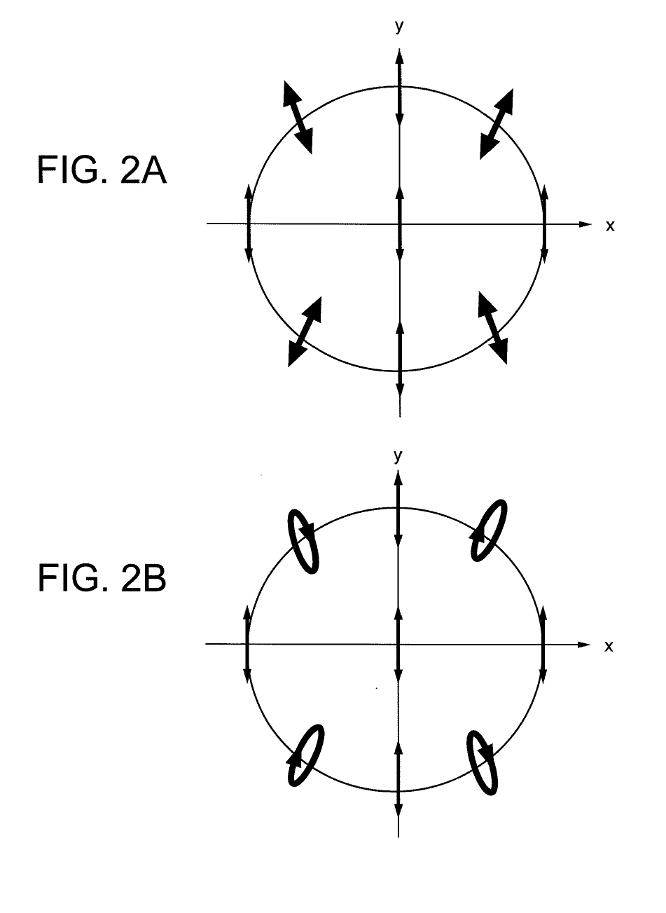

In a property of such coatings, such coating is generally designed to show optimum performance when an angle of incident light is normal, so that when the angle of incidence of the light passing through the lens is large such as a high magnification objective lens 5, rotation of polarization direction shown in FIG. 2A is generated in areas other than x-axis or y-axis (when incident light is polarized in y-axis direction). This arises from difference in refractive indices of p-polarization component and s-polarization component of incident linearly polarized light in accordance with the incident angle, as a result, the direction of polarization of light coming out from the lens rotates with respect to the incident linearly polarized light. Moreover, when a multilayer antireflection coating is applied on large number of lens surfaces, phase difference is generated between p-polarization component and s-polarization component, so that not only rotating direction of linearly polarized light, but also coming to elliptically polarized light as shown in FIG. 2B. Rotation of polarization direction and generation of elliptically polarized light caused by the generation of phase difference as shown in FIGS. 2A and 2B lower the extinction ratio of the polarization microscope, contrast of an image and a signal to noise ratio.

In the polarization compensation optical system (transmission-illumination-type polarization microscope) according to the first embodiment, with the aim of compensating rotation of polarization direction and phase difference caused by the optical system, a polarization compensation optical element C1 that compensates rotation of polarization direction and phase difference caused by an optical system disposed between the polarizer P and the condenser lens 3 is inserted in the vicinity of a primary focal plane of the condenser lens 3 of the illumination optical system shown in FIG. 1. Moreover, a polarization compensation optical element C2 that compensates rotation of polarization direction and phase difference caused by an optical system disposed between the objective lens 5 of the imaging optical system and the analyzer A is inserted.

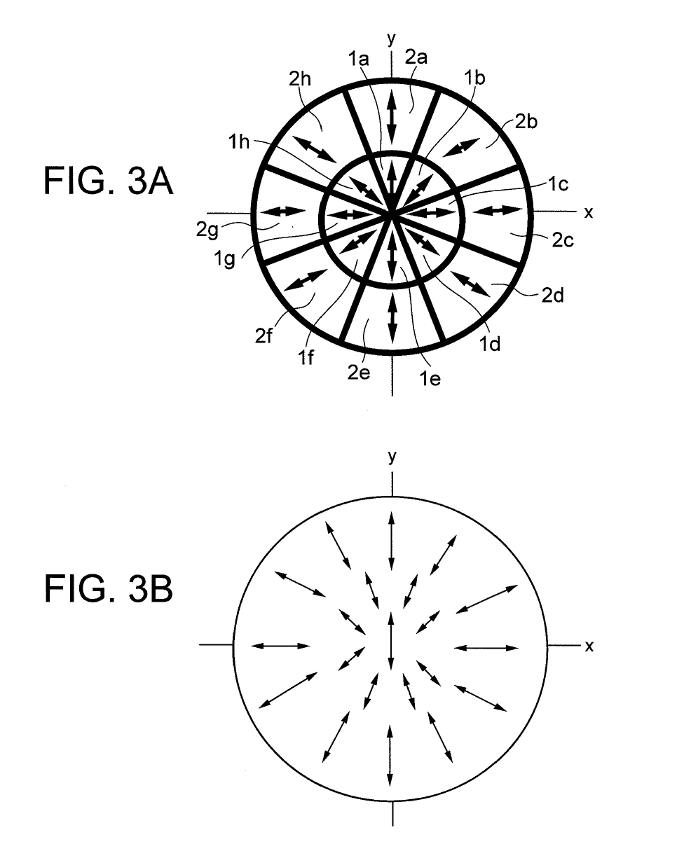

As shown in FIG. 3A, polarization compensation optical elements C1 and C2 are so-called divided-type phase plates in which an area in the effective diameter of the optical system is divided in the circumferential direction and in the radial direction, and a phase plate corresponding to rotation of polarization direction and phase difference of each divided area (for example, 1a through 1h, 2a through 2h in FIG. 3A) is disposed. Axes (a fast axis or a slow axis) of respective phase plates in the divided-type phase plate are disposed with orienting different directions with each other corresponding to optical property of the optical system. In FIG. 3A and FIG. 3B explained later, although polarization compensation optical systems [sic] C1 and C2 are explained in the same drawing, phase difference of the phase plate and direction of polarization of the axes the phase plate are different in accordance with optical property of the optical system in which the polarization compensation optical element C1 or C2 is inserted.

When divided areas of the polarization compensation optical element C1, which is a divided-type phase plate, are denoted by 1a through 1h, 2a through 2h, and phase differences of respective phase plates are denoted by δ1a through δ1h, δ2a through δ2h, phase differences are designed to compensate rotation of polarization direction and phase difference caused by all of optical elements disposed between the polarizer P and the condenser lens 3 except the polarization compensation optical element C1 with respect to light passing through respective divided areas in FIG. 1. Similarly, when divided areas of the polarization compensation optical element C2, which is a divided-type phase plate, are denoted by 1a through 1h, 2a through 2h, and phase differences of respective phase plates are denoted by δ1a through δ1h, δ2a through δ2h, phase differences are designed to compensate rotation of polarization direction and phase difference caused by all of optical elements disposed between the objective lens 5 and the analyzer A except the polarization compensation optical element C2 with respect to light passing through respective divided areas in FIG. 1.

Incidentally, the number of division and the shape of division of the polarization compensation optical elements C1 and C2 are not limited to the one shown in FIG. 3A, any number of division and any shape can be used. A portion of divided area may not be applied a phase difference, in other words, an area not having an effect of phase plate may be provided.

As a result, light passed through the optical system of the transmission-illumination-type polarization microscope shown in FIG. 1 (no sample is placed) is compensated rotation of polarization direction and phase difference in accordance with the polarization property of the optical system by the polarization compensation optical elements C1 and C2, so that high extinction ratio can be secured and a high contrast enlarged image 6 can be formed upon observing the sample 4.

Incidentally, the polarization compensation optical elements C1 and C2 can be constructed by a structural birefringent optical member, a resin phase plate, or a photonic crystal. The structural birefringent optical member uses a fact that a grating whose pitch is sufficiently smaller than a wavelength can act as a polarizer or a phase plate. With changing the pitch of the grating, a given phase difference and phase axis can be given. With changing the pitch and the direction of the grating in every divided area 1a through 1h, 2a through 2h shown in FIG. 3A, it becomes possible to realize the divided-type phase plate shown in FIG. 3A. Moreover, with changing the pitch and the direction of the grating such a manner that the phase axis and the phase difference in the effective diameter of the optical system gradually change as shown in FIG. 3B, it becomes possible to realize a gradient-type phase plate. In an ordinary resin phase plate, the phase axis and the phase difference are given by using birefringence of the resin material. By cementing resin phase plates having different phase axes and different phase differences, divided type phase plate as shown in FIG. 3A can be realized. In resin material, with controlling tension stress in each direction upon manufacturing the resin phase plate, it becomes possible to continuously change the phase axis and the phase difference of a single resin phase plate, so that the gradient phase plate shown in FIG. 3B can be realized.

A photonic crystal is a functional optical crystal having three dimensional construction. With changing three-dimensional construction parameters, it becomes possible to fabricate a given optical property such as the phase difference and the phase axis. When a divided-type phase plate as shown in FIG. 3A is fabricated by using the photonic crystal, because of high degree of freedom for designing, a phase plate having a wide-band wavelength property can be fabricated, and, for example, it is effective for a color observation optical system with white light. Furthermore, with changing three-dimensional construction parameters so as to gradually change the phase axis and phase difference in the effective diameter of the optical system as shown in FIG. 3B, it becomes possible to realize the gradient phase plate.

In this manner, since the polarization compensation optical elements C1 and C2 have the similar functions and effects to the optical system, so that the polarization compensation optical element C1 is explained as a representative.

In the case that the polarization compensation optical element C1 is constructed by a structural birefringent optical member, compensation for rotation of polarization direction and phase difference is explained in detail. When the polarization compensation optical element C1 is constructed by a structural birefringent optical member, there are two construction methods.

### (First Construction Method)

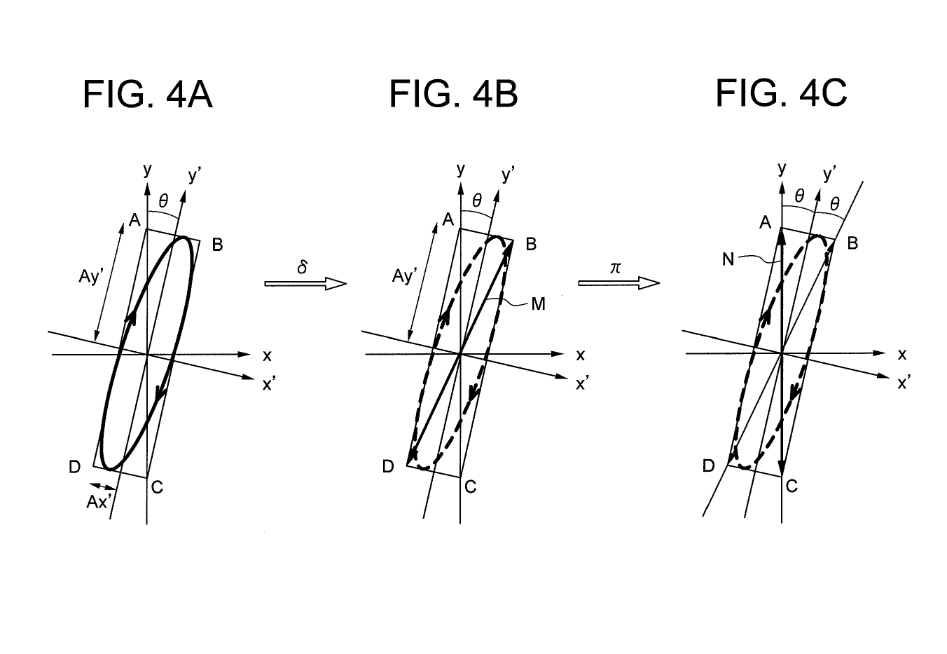

In the first construction method, compensation for the rotation of polarization direction and compensation for phase difference are carried out by a single surface of a structural birefringence optical member. In FIGS. 4A through 4C, incident linearly polarized light polarized in y-direction becomes elliptically polarized light by the rotation of the polarization direction and the phase difference δ generated by the optical system, and becomes an elliptically polarized state shown in FIG. 4A. In this instance, a quadrilateral ABCD which circumscribes the ellipse is drawn. In the quadrilateral ABCD, a quadrilateral whose diagonal AC comes to y-axis is chosen. The direction θ of the fast axis (y′ axis in the drawings) of the structural birefringence optical member is chosen to satisfy the following expression:

Ax′/Ay′=tan θ.

As shown in FIG. 4B, when the light passes through the structural birefringent optical member formed to compensate phase difference δ, the elliptically polarized light is changed to linearly polarized light M in a polarized direction shown by an arrow. Moreover, with adding a characteristic of a half-wave plate (providing a phase difference Π) to the structural birefringent optical member as shown in FIG. 4C, the linearly polarized light N becomes the same linearly polarized light as the incident light whose direction of polarization is y-axis. With constructing the structural birefringent optical member giving phase difference 6 and n, elliptically polarized light (FIG. 4A) caused by the optical system can be returned to original, incident linearly polarized light.

The first construction method can be accomplished in such a manner that one structural birefringent optical member compensates the phase difference combined two kinds of phase differences 6 and n.

### (Second Construction Method)

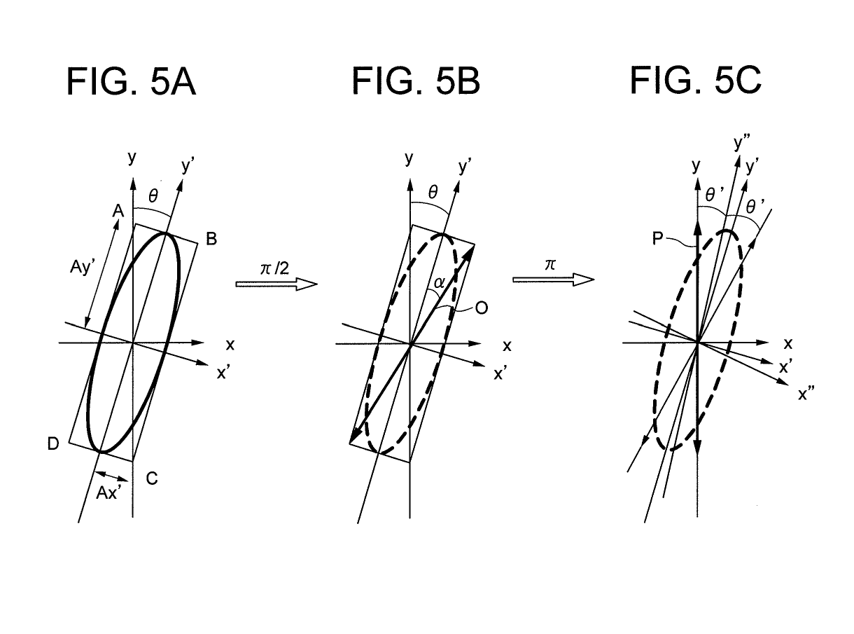

The second construction method uses at least two (back and front) surfaces of structural birefringent optical member. In FIGS. 5A through 5C, incident linearly polarized light polarized in y-direction becomes elliptically polarized light by the rotation of polarization direction and the phase difference 5 generated by the optical system, and becomes an elliptically polarized state shown in FIG. 5A. An angle formed by an axis (y-axis) of the original incident linearly polarized light and a major axis (fast axis: y′-axis) of the elliptically polarized light is denoted by θ. Here, when a first structural birefringent optical member is constructed to add a phase difference Π/2, an elliptically polarized light passed through the first structural birefringent optical member is converted to linearly polarized light O having an angle α with respect to y′-axis. Moreover, when a second structural birefringent optical member whose direction of fast axis (y″-axis) shows θ′=(θ+α)/2 is constructed to add phase difference Π, linearly polarized light O passed through the second structural birefringent optical member is converted into linearly polarized light P parallel to y-axis to return to the direction of incident linearly polarized light.

In this manner, the first structural birefringent optical member has a property to add phase difference of Π/2 (the same as a quarter-wave plate), and the second structural birefringent optical member has a property to add phase difference of n (the same as a half-wave plate), so that elliptically polarized light caused by the optical system can be returned to original linearly polarized light. In other words, the second construction method makes it possible to compensate rotation of polarization direction and phase difference by combining a quarter-wave plate and a half-wave plate, and has a characteristic to be easy to be fabricated.

In FIG. 1, although polarization compensation optical elements C1 and C2 can be disposed at any position in the optical system, in the illumination optical system, it is preferably disposed at the pupil position of the illumination optical system (in other words, the primary focal point of the condenser lens 3). Moreover, in the imaging optical system, although it may be disposed in the vicinity of the secondary focal point of the objective lens 5, when the polarization compensation optical element C2 is a divided-type phase plate, deterioration in optical performance caused by the structure in the vicinity of divided areas has to be taken into consideration.

Moreover, since the polarization compensation optical element according to the present embodiment has a plane parallel thin plate shape, it is easy to be inserted into or removed from the optical path, so that the polarization compensation optical element is easily exchanged, for example, upon exchanging lens for changing magnification. Furthermore, since it is not necessary to be installed into the lens system, an ordinary lens can be used without alteration.

In any of the first and second construction methods, necessary phase difference may be constructed by superimposing plurality of structural birefringent optical members. In other words, when the phase difference in the area 2a shown in FIG. 3A is denoted by δ2a, the phase difference δ2a is divided into n by satisfying the following expression (1), and n pieces of structural birefringent optical elements each having divided phase difference are superimposed to be δ2a in total, so that it is realized. However, the directions of the phase axes of the n pieces structural birefringent optical elements are the same in all pieces. This is not limited to the divided phase plate, the same to the gradient phase plate. The above-described construction is not limited to the structural birefringent optical elements, and it is possible to use a resin phase plate or a photonic crystal.

δ2a=δ2a1+δ2a2+δ2a3+δ2a4+ . . . +δ2a(n−1)+δ2an (1)

### (Variation)

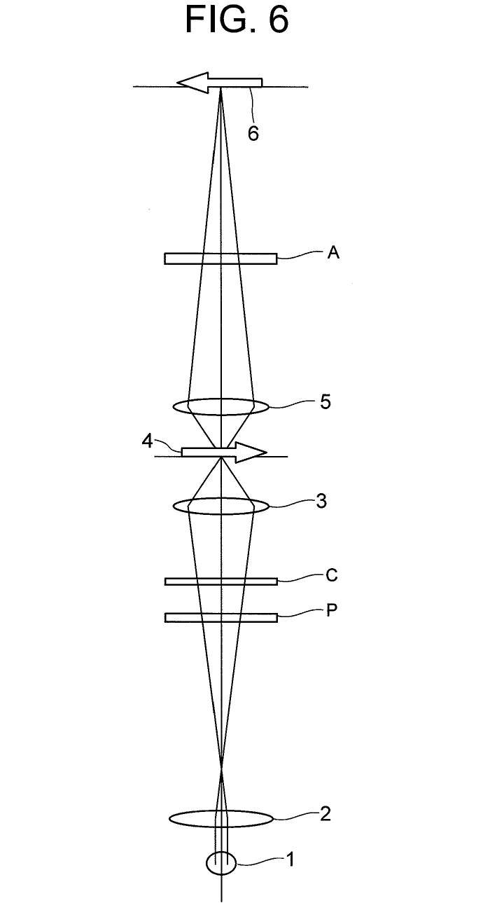

FIG. 6 is a schematic diagram showing a variation according to the first embodiment. The present variation is an example, which uses one polarization compensation optical element in the transmission-illumination type polarization microscope shown in FIG. 1. The same reference number is attached to the similar construction as the first embodiment to eliminate explanations thereof. In FIG. 6, a polarization compensation optical element C is disposed in the illumination optical system of the transmission-illumination type polarization microscope. The polarization compensation optical element C is disposed in the vicinity of a primary focal plane of a condenser lens 3. The polarization compensation optical element C has a property that compensates rotation of polarization direction and phase difference of the whole optical system in a state where a sample 4 is excluded. With constructing in this manner, it becomes possible to compensate rotation of polarization direction and phase difference of the whole optical system by the single polarization compensation optical element C. Incidentally, the polarization compensation optical element C may use both of the above-described first and the second construction methods of the structural birefringent optical member. Moreover, a resin phase plate or a photonic crystal may be used in the same way. The illumination light illuminating an object is not limited to polarized light transmitted through the polarizer P, and polarized light generated by reflecting a polarizer, or polarized light generated directly from a light source such as a laser light source may be used.

### Second Embodiment

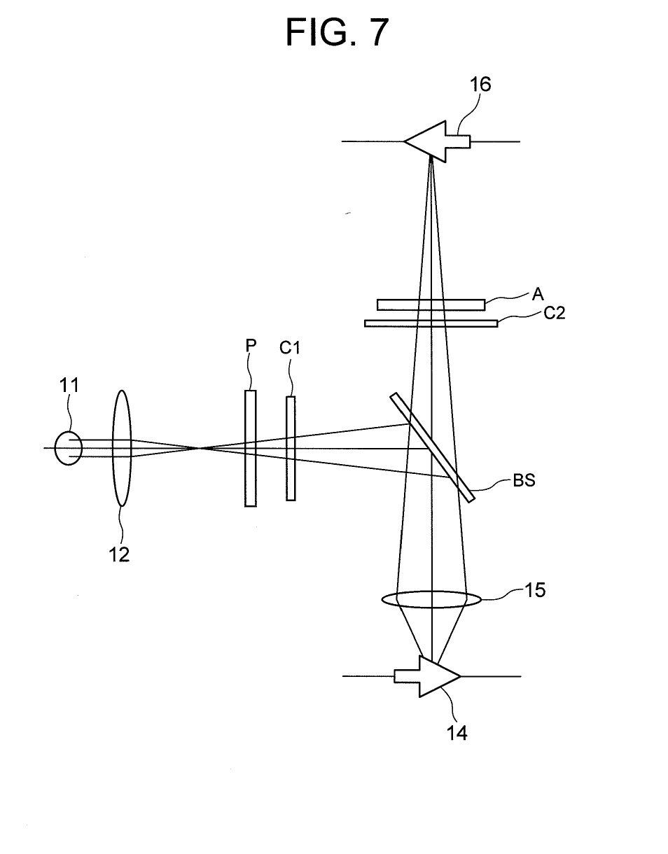

FIG. 7 is a schematic diagram showing a polarization compensation optical system according to a second embodiment of the present invention. In the second embodiment, an epi-illumination-type polarization microscope is taken up, and a polarization compensation optical system that compensates rotation of polarization direction and phase difference generated in the optical system is explained. In FIG. 7, illumination light from a light source 11 is converged by a collector lens 12, and incident on a beam splitter BS through a polarizer P and a polarization compensation optical element C1. The illumination light reflected by the beam splitter BS is incident on an objective lens 15, and illuminates a sample 14 placed on an unillustrated slide glass through the objective lens 15. Light from the illuminated sample 14 is converged by the objective lens 15 to form an enlarged image 16. An observer observes the enlarged image 16 by a naked eye through an unillustrated eyepiece. A polarization compensation optical element C2 and an analyzer A are disposed on an optical path between the objective lens 15 and the enlarged image 16. The polarizer P and the analyzer A are generally disposed such that the transmission directions of them are crossed at right angles (crossed Nicols disposition). The illumination light illuminating an object is not limited to polarized light transmitted through the polarizer P, and polarized light generated by reflecting a polarizer, or polarized light generated directly from a light source such as a laser light source may be used. Incidentally, the polarization compensation optical elements C1 and C2 may use both of the first and the second construction methods of the structural birefringent optical member similar to the first embodiment. Moreover, a resin phase plate or a photonic crystal may be used in the same way. In this manner, the epi-illumination-type polarization microscope is constructed. Furthermore, the function and the effect thereof are the same as the first embodiment, so that explanations are omitted.

### (Variation)

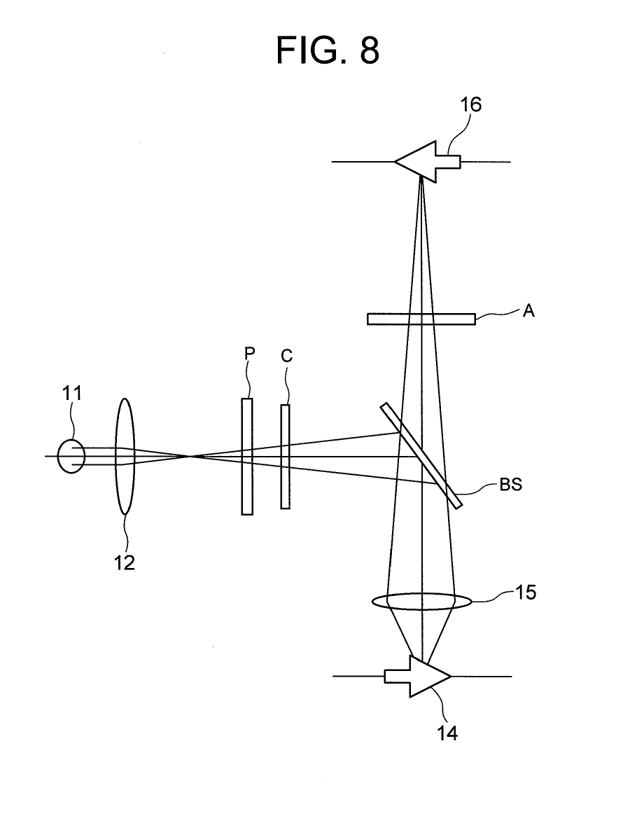

FIG. 8 is a schematic diagram showing a variation according to the second embodiment of the present invention. The variation is an example, in which a single polarization compensation optical element is used in the epi-illumination-type polarization microscope shown in FIG. 7. The same reference number is attached to the similar construction as the second embodiment to eliminate explanations thereof. In FIG. 8, a polarization compensation optical element C is disposed in an illumination optical system of the epi-illumination-type polarization microscope. The polarization compensation optical element C is disposed between a polarizer P and a beam splitter BS. The polarization compensation optical element C has a property that compensates rotation of polarization direction and phase difference of the whole optical system in a state where a sample 14 is excluded. With constructing in this manner, it becomes possible to compensate rotation of polarization direction and phase difference of the whole optical system by the single polarization compensation optical element C. Incidentally, the polarization compensation optical element C may use both of the above-described first and the second construction methods of the structural birefringent optical member. Moreover, a resin phase plate or a photonic crystal may be used in the same way. Moreover, although the polarization compensation optical element C may be disposed at any position between the polarizer P and the analyzer A, it is preferably disposed between the polarizer P and the beam splitter BS of the illumination optical system as shown in FIG. 8 since an effect of combining portion of a divided-type phase plate on optical performance can be small. The illumination light illuminating an object is not limited to polarized light transmitted through the polarizer P, and polarized light generated by reflecting a polarizer, or polarized light generated directly from a light source such as a laser light source may be used.

In the above-described embodiments, although cases for applying to a representative polarization microscope optical system are explained, the present invention may be applied to any optical system using polarized light such as, for example, an ellipsometer and a differential interference microscope, and polarization property of the optical system can be compensated. The above-described embodiments only show examples, so that the present invention is not limited to the above-described constructions or forms, and can suitably be corrected or changed within the scope of the present invention.

### (Examination Based on Simulation)

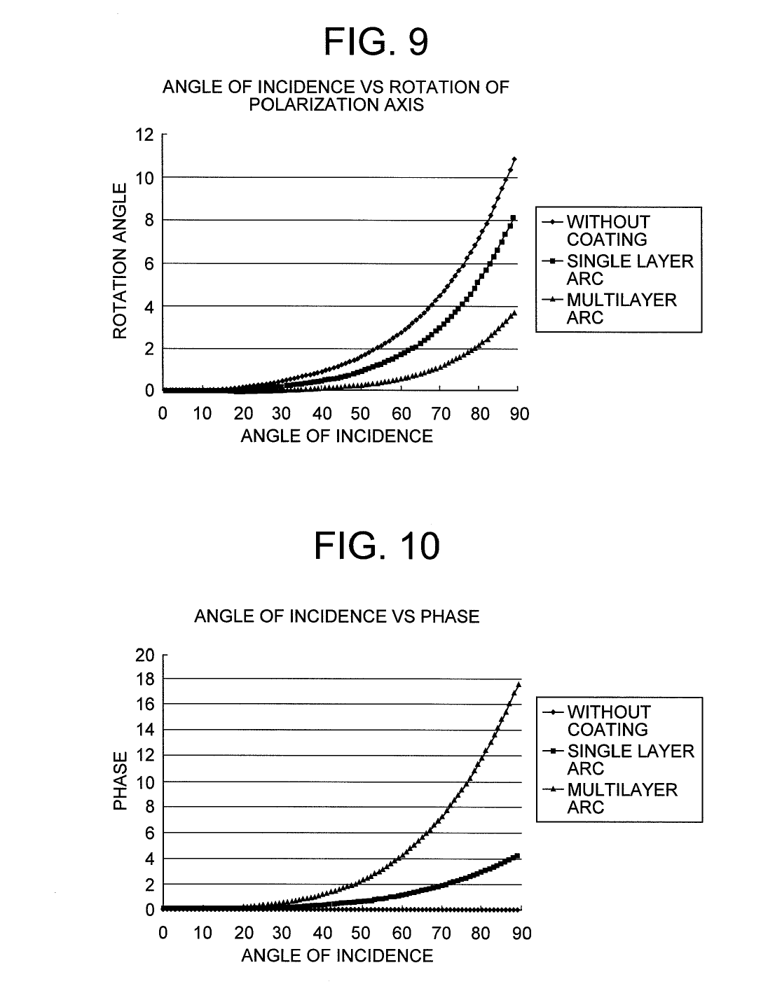

Polarization compensation effect is explained below in detail with quoting calculation result of simulation according to the present embodiment. FIG. 9 is a graph showing incident angle dependency of a rotation angle of polarization direction upon incident on a medium having refractive index of 1.5, in which a vertical axis is a rotation angle of polarization direction, and a horizontal axis is an angle of incidence of light. It is understood that the rotation angle of polarization direction drastically increases in accordance with increase in the angle of incidence. Moreover, when a single layer antireflection coating or a multilayer antireflection coating is applied, the rotation angle of polarization direction becomes smaller than the case without applying a coating.

Then, FIG. 10 is explained. FIG. 10 is a graph showing incident angle dependency of a phase difference, in which the vertical axis is a phase difference, and the horizontal axis is an angle of incidence. Phase difference is not generated upon applying no coating. Phase difference drastically increases in accordance with increase in the angle of incidence upon applying a single layer antireflection coating or a multilayer antireflection coating.

In a condenser lens and an objective lens, an angle of incidence of light on each lens surface averagely becomes large as the numerical aperture increases. There are various kinds of condenser lenses and objective lenses, and various kinds of single layer and multilayer antireflection coatings are applied to optical elements composing thereof. However, the reason to generate the rotation of polarization direction and the phase difference is the same. In other words, even if the absolute values of the rotation of polarization direction and phase difference are different in accordance with a combination of a condenser lens and an objective lens, it is unchangeable that light having larger numerical aperture makes larger rotation of polarization direction and phase difference. As shown in FIGS. 9 and 10, it is understood that rotation of polarization direction and phase difference increase as the numerical aperture of the optical system increases.

In a microscope optical system using linearly polarized light, an extinction ratio is given as a parameter for defining contrast and signal to noise ratio of an obtained image. The extinction ratio is a ratio of the maximum value to the minimum value of the light passed through the optical system. In a polarization microscope, transmission light takes maximum value when the transmission axes of the polarizer and the analyzer are parallel, which is an open Nicols state, and minimum value when the transmission axes of the polarizer and the analyzer are orthogonal, which is in a crossed Nicols state. Accordingly, an extinction ratio is adopted as a parameter for providing an effect of the polarization compensation optical system according to the present invention.

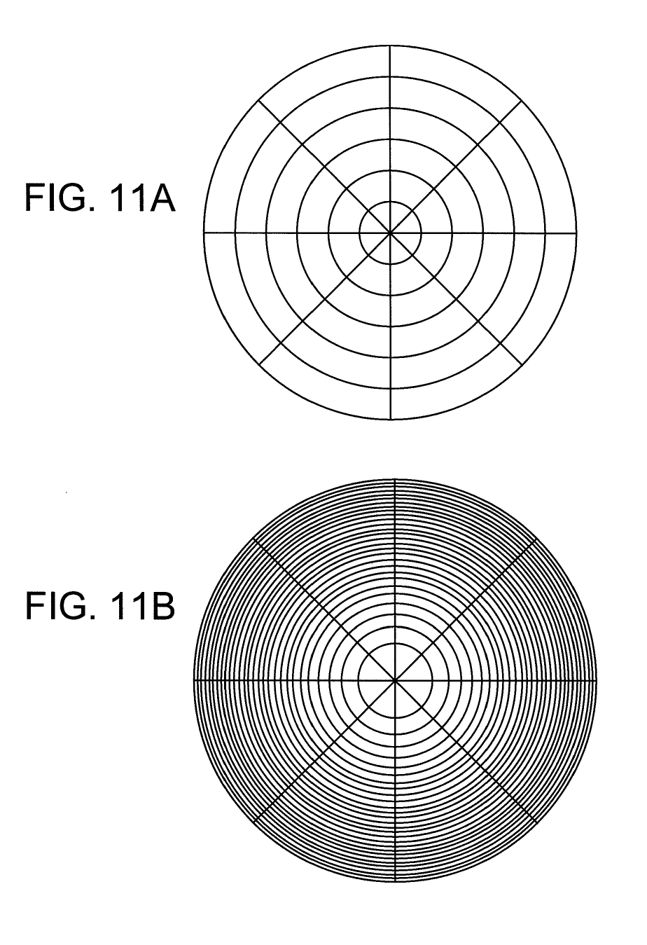

One of polarization compensation optical elements used for the simulation is an element shown, for example, in FIG. 11A. A rotation angle of polarization direction and ellipticity angle change along circumferential direction and radial direction. Accordingly, the polarization compensation optical element is divided also along circumferential direction and radial direction. The divided area has a finite dimension, so that rotations of polarization direction and phase differences are different among light rays passed through the same area. Accordingly, a light ray passed through a position where the area is equally divided in the circumferential direction and in the radial direction is made to be a representative light ray of the area, and an amount of correction of each area is set to correct rotation of polarization direction and phase difference of the light ray.

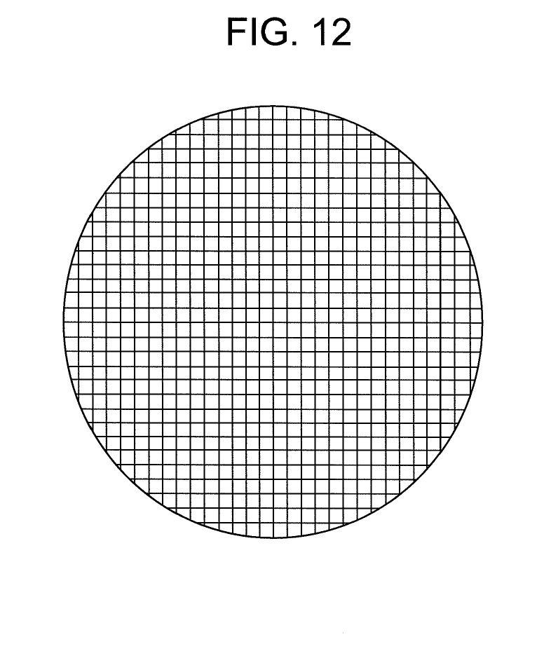

In the simulation, although a polarization compensation optical element equally divided in the radial direction and in the circumferential direction is used, as understood from FIGS. 9 and 10, since rotation angle of polarization direction and phase difference drastically increase as the angle of incidence increases, the area is preferably divided finer as the numerical aperture increases as shown in FIG. 11B. As shown in FIGS. 11A and 11B, when an area is divided in the radial direction and in the circumferential direction, the shape of an area becomes complicated with two arcs, so that inconvenience arise upon manufacturing thereof. Accordingly, it may be constructed by divided into areas having grid shape as shown in FIG. 12. Moreover, in this case also, a size of an area is preferably smaller in the periphery where the numerical aperture becomes large.

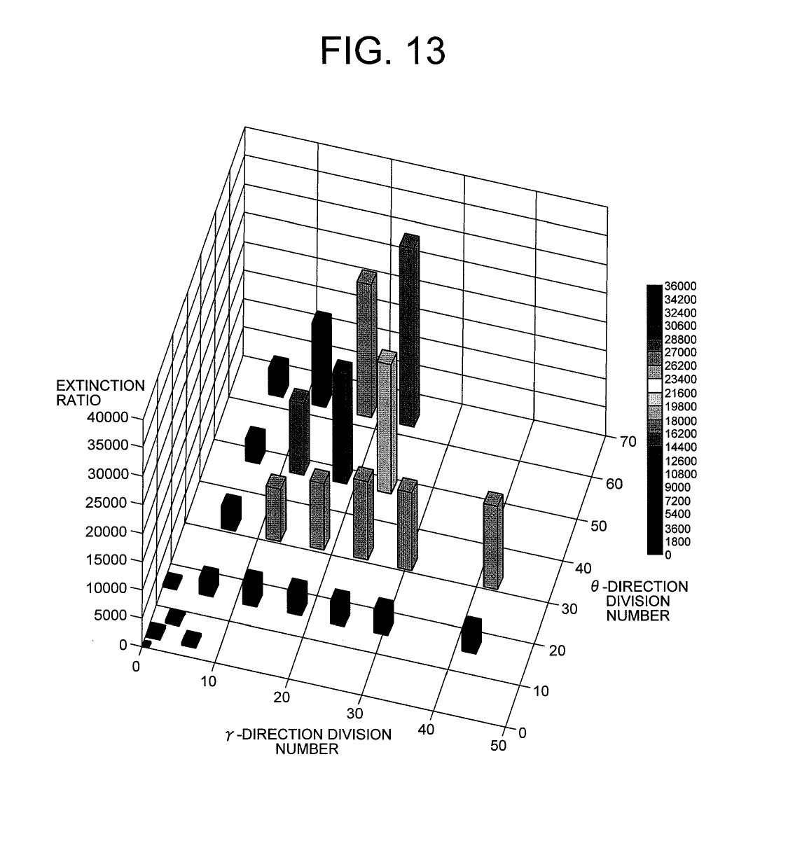

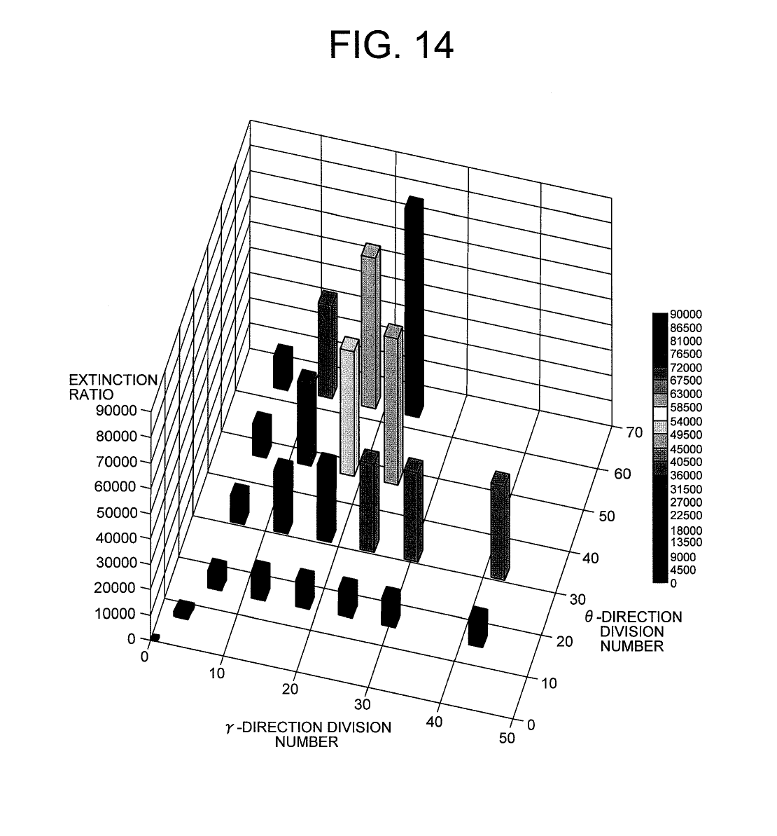

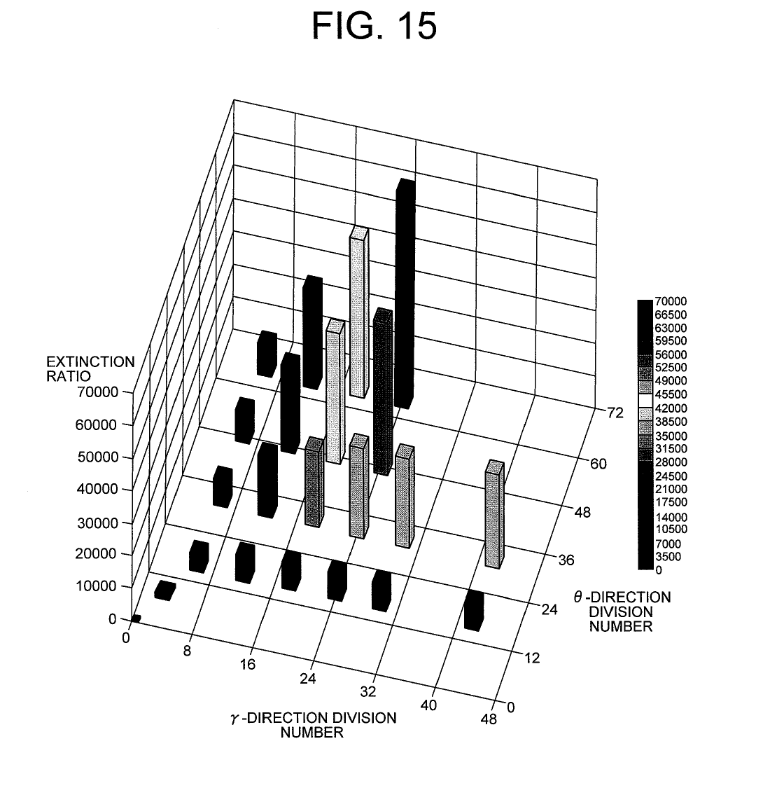

FIG. 13 is a graph showing a variation in extinction ratio of an optical system including polarization compensation optical system with respect to a circumferential direction division number and a radial direction division number of a polarization compensation optical element when one polarization compensation optical element is disposed in the vicinity of a primary focal plane of a condenser lens 3 as the variation of the first embodiment. An oil-immersion objective lens with a numerical aperture of 1.4 and a magnification of 60, and an oil-immersion condenser lens with a numerical aperture of 1.4 are used (which is to be an optical system 1). The oil-immersion objective lens with a numerical aperture of 1.4 and a magnification of 60 uses coatings on 17 surfaces. Among them, multilayer coating are applied on 4 surfaces. In the oil-immersion condenser lens with a numerical aperture of 1.4, coating are used on five surfaces, and only single layer coating is used. FIGS. 14 and 15 shows a calculation result carried out the similar calculation to an optical system with a higher numerical aperture different from the one shown in FIG. 13. FIG. 14 shows a case that an oil-immersion objective lens with a numerical aperture of 1.4 and a magnification of 60, and a dry condenser lens with a numerical aperture of 0.88 are used (which is to be an optical system 2). The number of coatings are total 23 surfaces, and a multilayer coating is used in 4 surfaces. FIG. 15 shows a case that an oil-immersion objective lens with a numerical aperture of 1.25 and a magnification of 100, and a dry condenser lens with a numerical aperture of 0.9 are used (which is to be an optical system 3). The number of coatings are 13, and a multilayer coating is not used. As stated above, despite of differences of a numerical aperture, a magnification, a single layer coating and a multilayer coating, extinction ratio increases the most effectively when the following conditional expression (2) is satisfied, in particular, when the following expression (3) is satisfied, increase in extinction ratio with respect to division number is large:

2≦β/α≦3 (2)

α:β=3:8 (3)

where α denotes a division number in the radial direction, and β denotes a division number in the circumferential direction.

As understood from this, in the present invention, although a variation is shown as an example in each of the first embodiment and the second embodiment, the result of the simulation and the effect of the present invention do not lack generality over entire aspects.

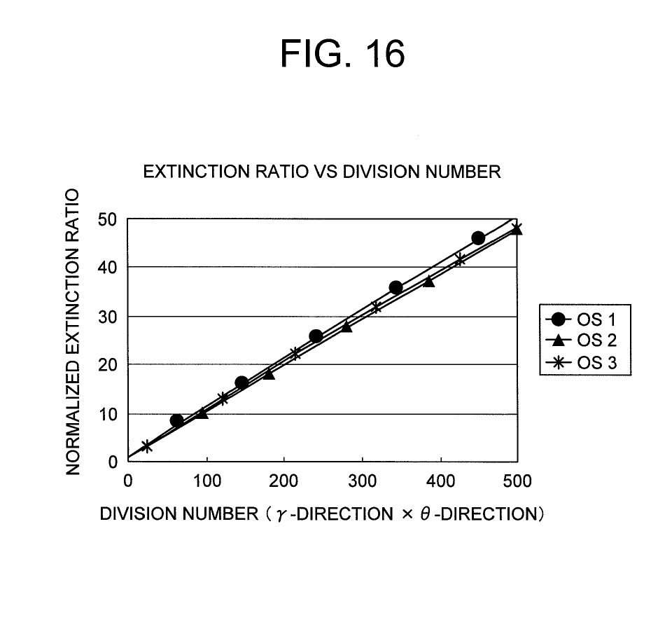

FIG. 16 is a graph showing a relation between extinction ratio and division number in the optical systems 1 through 3, in which the vertical axis shows extinction ratio normalized by an extinction ratio upon excluding the polarization compensation optical element, and the horizontal axis shows a total division number when α:β=3:8. It is understood that the extinction ratio increases with the same rate regardless of the optical system.

In a visual observation with a polarization microscope, it is generally known that phase difference detection sensitivity of a sample is almost inversely proportional to a square root of the extinction ratio. Incidentally, an intended purpose of a polarization microscope is for investigating optical isotropy and anisotropy of a sample, so that generally it has often been used for a rock, a mineral and a polymer. However, nowadays an opportunity to observe a biological sample increases. In order to observe a biological sample having finer structure than a mineral, both of resolving power (proportional to a numerical aperture) and phase difference detection sensitivity are required. However, as stated above, in an optical system with a high numerical aperture, an extinction ratio drastically decreases to become about 10² to 10³. An optical system whose numerical aperture is 1 or more, in particular, it is known that an extinction ratio is about 10². However, since an optical system with a low numerical aperture has an extinction ratio about 10⁴, in order that an optical system with a high numerical aperture has nearly equal phase difference detection sensitivity, an extinction ratio has to be increased 10 times or more. According to FIG. 16, it is understood that since the number of division and the normalized extinction ratio nearly have a linear relation, when the number of division is made to be 10² or more, an extinction ratio can be 10 times or more. In a differential interference microscope, although an extinction ratio is not necessary to be that of a polarization microscope, an extinction ratio of at least 2×10² is necessary for a biological sample having fine structure such as live cells. When the ratio is more than this, it is known that contrast and phase difference detection sensitivity increase proportional to the extinction ratio (Pluta. M, Advanced Light Microscopy, vol. 2).

Finally, the optimum area division for a polarization compensation optical element is explained on the basis of this calculation result and known facts. As stated above, in an observation with a high numerical aperture of a polarization microscope, in order to obtain the same extinction ratio as an optical system with a low numerical aperture, an area division number is necessary to be 10² or more. In a differential interference microscope, experience tells that when an extinction ratio increases 3 times or more, an observer can feel increase in contrast or phase difference detection sensitivity. According to FIG. 16, it is understood that since the number of division and the normalized extinction ratio nearly have a linear relation, when the number of division is made to be about 30, an extinction ratio can be 3 times or more. In particular, when α:β=3:8, in which the extinction ratio increases the most effectively, the division number is suitable to be 24. In an optical system symmetrical with respect to an optical axis, when transmission axes of a polarizer and an analyzer are crossed normally that is crossed Nicols state, polarization states of light passed through four areas bordered by the transmission axes of the polarizer and the analyzer are symmetrical with respect to respective axes. Therefore, the minimum division number in the circumferential direction becomes 4. On the other hand, in the radial direction, there is no symmetry, so that the minimum division number becomes 2. Accordingly, the minimum area division number for making an effect as a polarization compensation optical element is understood to be 8. In other words, the polarization compensation optical element is constructed with satisfying the following conditional expression (4):

8≦N (4)

where N denotes an area division number.

However, as stated above, it is understood that increase in the extinction ratio is not sufficient when the number of division is 8. However, as shown in FIG. 11B when the division in the radial direction is made non-linearly without dividing at regular intervals, improvement can be shown with fewer division number.

What is claimed is:

1. A polarization compensation optical system comprising:
an illumination optical system that illuminates a sample with polarized illumination light;
an imaging optical system that images the light from the sample whose polarization state is varied by the sample through an analyzer; and
a polarization compensation optical element that is disposed at least one of the illumination optical system and a space between the sample and the analyzer, and corrects rotation of polarization direction and phase difference generated by optical elements disposed between the sample and the analyzer, and optical elements disposed in the illumination optical system;
the polarization compensation optical element being divided into a plurality of areas in a circumferential direction and in a radial direction on an optical axis of the illumination optical system and the imaging optical system, when a number of division of the plurality of areas is denoted by N, the number of division in the radial direction is denoted by α, and the number of division in the circumferential direction is denoted by β,
the following conditional expressions being satisfied:
8≦N
2≦β/α≦3.

2. The polarization compensation optical system according to claim 1, wherein a phase plate is disposed in each area of the polarization compensation optical element, and the phase plate is made of a structural birefringent optical member.

3. The polarization compensation optical system according to claim 1, wherein a phase plate is disposed in each area of the polarization compensation optical element, and the phase plate is made of a photonic crystal.

4. The polarization compensation optical system according to claim 1, wherein the polarization compensation optical element is formed by a plurality of layers including:
a first division-type phase plate that is formed by disposing and combining a plurality of quarter-wave plates with orienting phase axes thereof to respective given directions corresponding to the plurality of areas whose phase differences are different with each other; and
a second division-type phase plate that is formed by disposing and combining a plurality of half-wave plates with orienting phase axes thereof to respective given directions corresponding to the plurality of areas whose phase differences are different with each other.

5. The polarization compensation optical system according to claim 1, wherein the quarter-wave plate and the half-wave plate are made of a structural birefringent optical member.

6. The polarization compensation optical system according to claim 1, wherein the quarter-wave plate and the half-wave plate are made of a photonic crystal.

7. The polarization compensation optical system according to claim 1, wherein the polarization compensation optical element is divided in a grid shape.

8. The polarization compensation optical system according to claim 1, wherein the illumination optical system includes a polarizer, and the polarized illumination light is formed by the polarizer.

9. A polarization compensation optical element, whose effective diameter is divided into a plurality of areas in a circumferential direction and in a radial direction, for compensating rotation of polarization direction and phase difference, the polarization compensation optical element comprising:
phase plates each of which is disposed in each area composed of at least one layer for providing different phase difference, and orient respective phase axes thereof to given directions different with each other; and
the following conditional expressions being satisfied:
8≦N
2≦β/α≦3
where N denotes a number of division of the areas of the polarization compensation optical element, α denotes the number of division in the radial direction, and β denotes the number of division in the circumferential direction.

10. The polarization compensation optical element according to claim 9, wherein the phase plate is made of a structural birefringent optical member.

11. The polarization compensation optical system according to claim 9, wherein the phase plate is made of a photonic crystal.

12. The polarization compensation optical element according to claim 9, wherein the phase plate is formed by a plurality of layers including:
a first division-type phase plate that is formed by disposing and combining a plurality of quarter-wave plates with orienting phase axes thereof to respective given directions corresponding to the plurality of areas whose phase differences are different with each other; and
a second division-type phase plate that is formed by disposing and combining a plurality of half-wave plates with orienting phase axes thereof to respective given directions corresponding to the plurality of areas whose phase differences are different with each other.

13. The polarization compensation optical element according to claim 9, wherein the quarter-wave plate and the half-wave plate are made of a structural birefringent optical member.

14. The polarization compensation optical element according to claim 9, wherein the quarter-wave plate and the half-wave plate are made of a photonic crystal.

15. The polarization compensation optical element according to claim 9, wherein the effective diameter is divided in a grid shape.
